(19) United States
(12) Patent Application Publication
(10) Pub. No.: US 2006/0016566 A1
(43) Pub. Date: Jan. 26, 2006

(54) High-speed roll-up door assembly

(76) Inventors: Walenty Kalempa, Slinger, WI (US); Brian Norbert Drifka, Richfield, WI (US)

Correspondence Address: FACTOR & LAKE, LTD, 1327 W. WASHINGTON BLVD., SUITE 5G/H, CHICAGO, IL, 60607, US

(21) Appl. No.: 11/184,112

(22) Filed: Jul. 18, 2005

Related U.S. Application Data
(60) Provisional application No. 60/589,163, filed on Jul. 18, 2004.

(51) Int. Cl. E06B 3/48

(52) U.S. Cl. 160/181

(57) ABSTRACT

The present invention is directed to a system and method for improving the manufacturability and utility of a high-speed roll-up door. The high-speed roll-up door includes a frame positioned about an opening. The system comprises a fixed panel, a removable panel, and a connector assembly. The connector assembly is fixedly attached to one of the fixed or removable panels and facilitates the attachment and detachment of the removable panel with the fixed panel. In addition, the present invention comprises a secondary control module operably connected to a primary control module and readily accessible to manual operation by a user. The secondary control module is remotely located with respect to the primary control module.

### CROSS-REFERENCE TO RELATED APPLICATION

This application claims priority to U.S. Provisional Patent Application Ser. No. 60/589,163, filed Jul. 18, 2004, which is incorporated herein by reference.

### TECHNICAL FIELD

The present invention relates to high-speed roll-up doors. More specifically, the present invention involves improved manufacturability and assembly of high-speed roll-up doors.

### BACKGROUND OF THE INVENTION

Many factors are considered during the design of a product intended for commercial or industrial use. Such factors include, and are not limited to: time, cost, safety, manufacturability, repairability, quality, and intended use.

Design considerations relating to a product's manufacturability involve: use of components across various product lines, inventory and availability of components, and, product complexity and installation. The utilization of common component parts throughout a product line may save costs. And facilitating the installation and assembly of the product may improve its marketability.

The present invention is provided to address these and other considerations.

### SUMMARY OF THE INVENTION

The present invention is directed to improving the utility of a high-speed roll-up door. One embodiment of the present invention includes an apparatus providing access to a primary control module of a high-speed roll-up door. The primary control module includes a set of control functions and is inaccessible to a user during utilization of the door. The apparatus comprises a secondary control module operably connected to the primary control module and readily accessible to manual operation by a user. The secondary control module is remotely located with respect to the primary control module. Additionally, the secondary control module includes a reduced set of control functions as compared to the set of control functions of the primary control module.

Another embodiment of the present invention is directed to a system for facilitating the assembly of a high-speed roll-up door assembly. The high-speed roll-up door assembly includes a frame positioned about an opening. The assembly further comprises a fixed panel, a removable panel, and a connector assembly. The connector assembly is attached to one of the fixed or removable panels and facilitates the attachment and detachment of the removable panel with the fixed panel.

Other advantages and aspects of the present invention will become apparent upon reading the following description of the drawings and detailed description of the invention.

### BRIEF DESCRIPTION OF THE DRAWINGS

FIG. 1 depicts a commonly known high-speed roll-up door system utilizing a single control module;

FIG. 2 depicts one embodiment of the present invention incorporating a remote control module;

FIG. 3 is a partial perspective drawing of another embodiment of the present invention;

FIGS. 4A-C depict several aspects of the panel opening of the present invention;

FIG. 5 is a perspective side view of one aspect of the connector assembly of the present invention;

FIG. 6 is a side view of one aspect of the connector assembly of the present invention;

FIG. 7 is a cross-sectional view of the connector assembly shown in FIG. 6; of the present invention;

FIG. 8 is a cross-sectional perspective view of one aspect of the connector assembly of the present invention with the removable panel not shown; and,

FIG. 9 is a cross-sectional perspective view of one aspect of the connector assembly of the present invention with the removable panel attached to the fixed panel.

### DETAILED DESCRIPTION

While the present invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

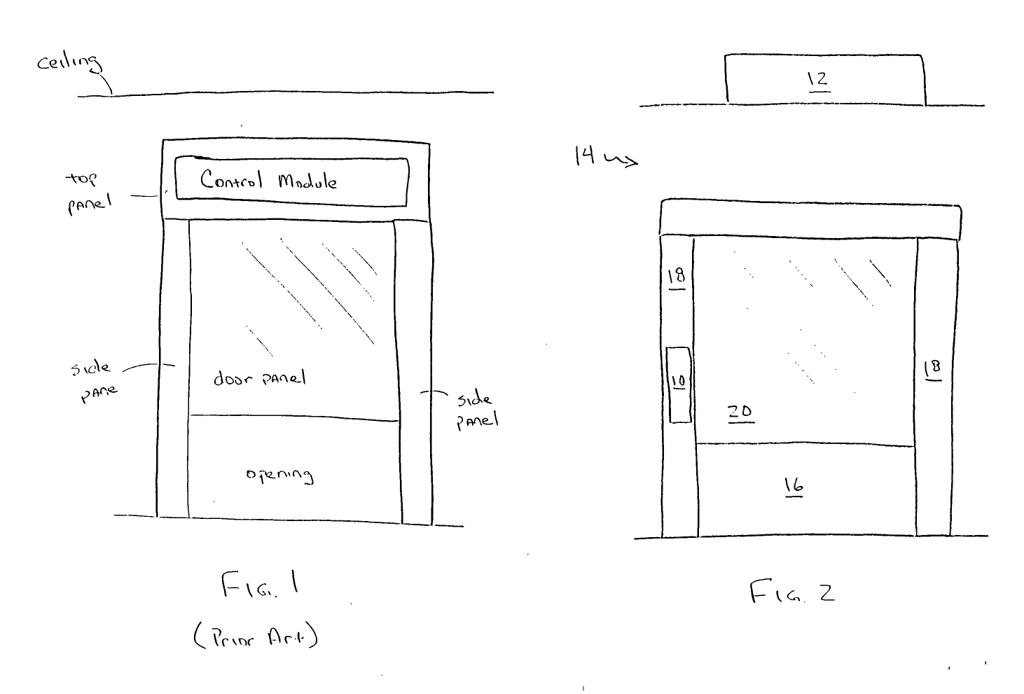

FIG. 1 depicts a high-speed roll-up door assembly known in the prior art. The door assembly includes a control module operably connected to the door panel. Mechanisms for moving the door panel are operably connected to the control module and the door panel. The mechanisms, e.g., pulleys, ballasts, gears, etc., are generally located above and to the side of the opening and at least partially contained within top and side panels. The control module is typically located near a side panel and is readily accessible to a user; that is, the user does not have to extend non-customary efforts, such as using a ladder to reach the control module, etc. The control module includes nearly everything involving and relating to operating the high-speed roll-up door assembly, e.g., processors, power transformers, diagnostic routines, mechanical and electrical drive units, circuit boards, electronic components, software modules, sensors, visual indicators and/or monitors, human-machine interface, etc.,

Referring to FIG. 2, the present invention is directed to an apparatus 10 providing access to a primary control module 12 of a high-speed roll-up door assembly 14. The primary control module 12 includes a set of control functions and typically is located above a door opening 16, e.g., above the ceiling, and generally inaccessible—out of reach—to a user during utilization of the door. The apparatus of the present invention comprises a secondary control module 10 operably connected to the primary control module 12. The secondary control module 10 is located remotely from the primary control module 12 and near the door opening 16, preferably residing at least partially, within a side door panel 18. The remotely located secondary control module 10 is readily accessible—within reach—to the user; as opposed to the primary control module 12.

The secondary control module 10 includes a reduced set of control functions compared to the set of control functions of the primary control module 12. While the primary control module 10 includes nearly everything involved with operating the high-speed roll-up door assembly 14, the reduced set of control functions include, but is not limited to: direct control of the door panel 20, system error override, power access, and any combination thereof. Preferably, some of the mechanisms for moving the door panel 20 do not reside near the secondary control module 10.

Through the secondary control module 10, the user is provided with the ability to communicate with the primary control module 12. Preferably, most of the procedures used to overcome many of the commonly occurring faults that render the door assembly 14 temporarily inoperable will be accessible to the user through the secondary control module 10. For instance, if the high-speed roll-up door assembly 14 of the present invention becomes inoperable, the user may quickly access the secondary control module 10 and attempt to make the door operable, e.g., turn the power to the system on, off, or cycle it; directly drive the door panel 20 to an open or closed position, etc. If further functionality is necessary and not available through the secondary control module 10, the user will be required to access the primary control module 12—remote from the secondary control module—to proceed further, e.g., execute diagnostics, replace drive units, repair/replace circuit boards and/or components, etc.

There are many significant advantages of utilizing a compact, remote, and functionally sufficient secondary control module 10 operably connected to the larger, fully functional primary control module 12. A smaller control unit is often preferred because it does not use valuable space near the door assembly 14. The limited, yet effective, functionality provided by the secondary control module 10 of the present invention allows the significantly smaller secondary control unit to be implemented near the door opening without crowding the area. The smaller size also allows the secondary control module 10 to be placed in a safer location—less susceptible to damage by incidental contact—yet still near the door assembly 14.

In addition, significant design and engineering efforts would be required to reduce the larger size of today's control module to make it comparatively appealing to the control system of the present invention. Sizeable costs may also be incurred to redesign larger control modules so that smaller components and mechanisms capable of performing functions required of larger components may be utilized.

For door system implementations involving strict requirements, e.g., clean rooms, pharmaceutical manufacturing, integrated circuit manufacturing, etc., all the components of a control module located near the door opening may be required to be in compliance with several environmental or industrial standards, e.g., NEMA Ratings. As such, efforts to obtain NEMA qualification for the smaller secondary control module of the present invention will be less than that required for the larger control unit incorporating many more components. The fewer components utilized in the secondary control module 10 of the present invention would involve less cost than the single, full-sized primary control module. An additional concern for the larger commonly used control unit is that some components not utilized in the limited secondary control module, e.g., mechanical or electrical drive units and transformers, may be conducive to producing adverse operating and environmental conditions, e.g., dirt, dust.

Incorporation of the primary 12 and secondary 10 control module units of the present invention may also provide manufacturability benefits as compared to the single control unit door assembly. More specifically, for situations requiring a substantially smaller control unit than used in the past, the present invention provides for the continual use of the larger control modules by remotely positioning the larger control module away from the door opening area. Without the use of the secondary control module 10 of the present invention, significant costs associated with reengineering the larger control module would be incurred. Thus, utilizing the secondary control module 10 of the present invention may allow continual use of existing control modules and avoid the effort and cost to redesign them for specific purposes.

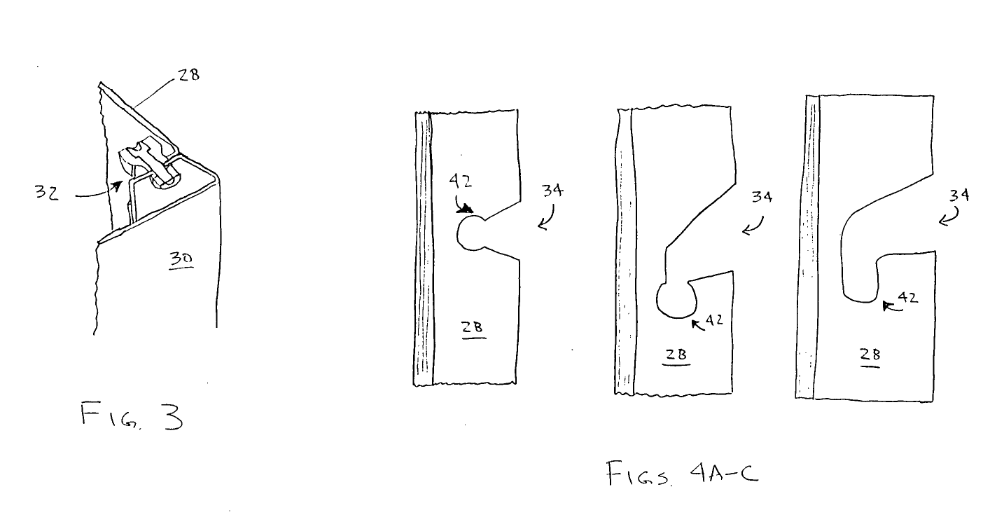

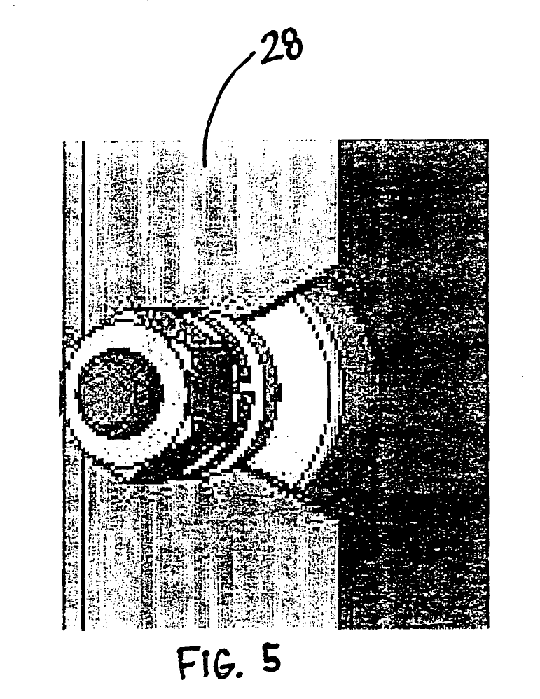

Another embodiment of the present invention is directed to facilitating the assembly of a high-speed roll-up door system 22 including a frame 24 positioned about a door opening 26. Shown in FIGS. 3-9, this embodiment includes a fixed panel 28, a removable panel 30, and a connector assembly 32 attached to one of the fixed or removable panels. The connector assembly 32 facilitates attaching and detaching the removable panel 30 with the fixed panel 28.

An additional aspect of the connector assembly 32 of the present invention includes a panel opening 34 being defined by the fixed panel 28 (or the removable panel 30). A bolt 36 is attached to the either the removable panel 30 or the fixed panel 28 through use of a retention nut 38 operably connected to the bolt. Alternatively, the bolt 36 may be attached to the panel through any means known to one of ordinary skill in the art, i.e., threaded fit, friction fit, etc. The retention nut 38 cooperates with the panel opening 34 defined in the other of the removable panel 30 or the fixed panel 28 and facilitates attaching and detaching the removable panel with the fixed panel. Additionally, an interference nut 40 may be operably connected to the panel wall opposite the retention nut 38. The interference nut 40 cooperates with the panel opening 34 to retain the fixed 28 and removable 30 panels together.

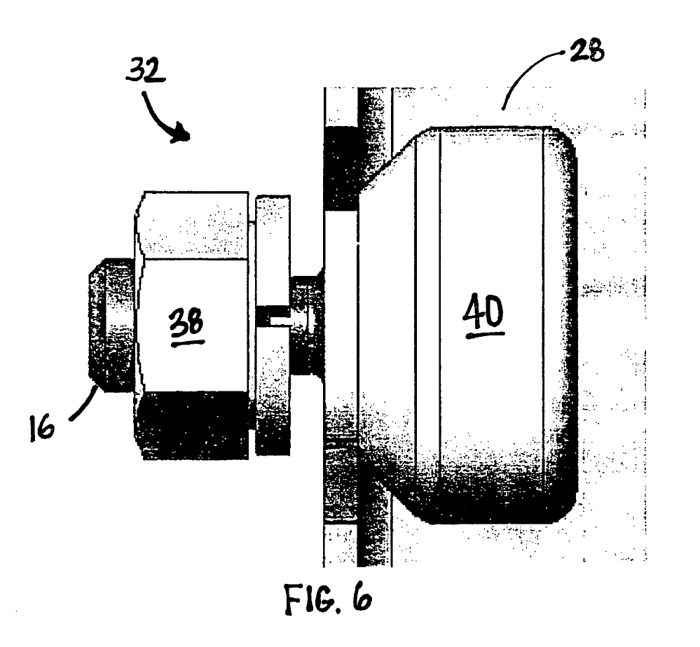

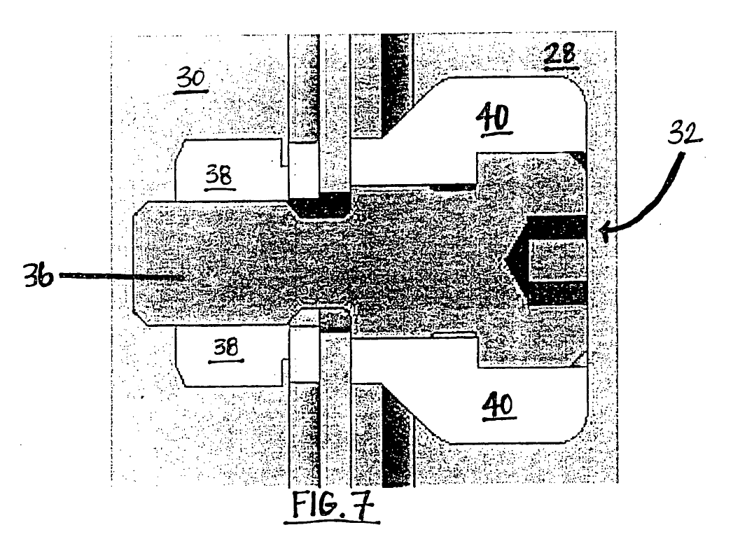

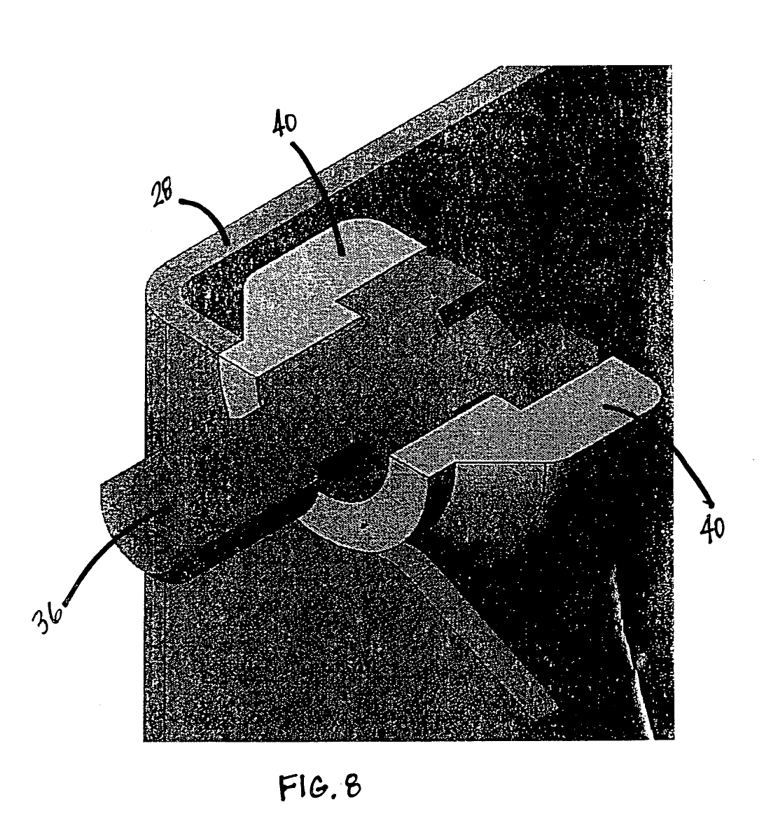

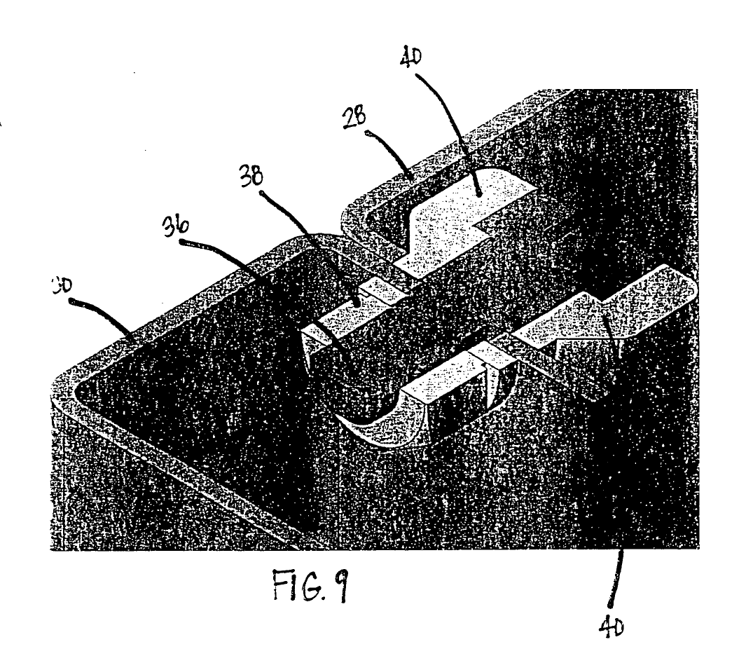

As shown in FIGS. 4A-C, the panel opening 34 may be constructed in various configurations, e.g., straight, hooked, curved, slanted, and any combination thereof. Preferably, the edges of the panel opening 34 taper to a connection point 42 to receive the interference nut 40 so as to detachably couple the removable panel 30 to the fixed panel 28. The interference nut 40 may be frictionally-fit, press-fit, or snap-fit to the connection point 42. The interference nut 40 comprises a material capable of temporarily flexing to cooperate with the panel opening 34. Such material is known to those of ordinary skill in the art and may include nylon and the like. In addition, the opening may include a sleeve 44 constructed of a nylon-like material capable of temporarily flexing to cooperate with the bolt 36 itself, or interference nut 40.

In a connector assembly 32 utilizing a press-fit configuration, the panel opening 34 tapers to a dimension operably less than the dimension of the bolt 36—or the interference nut 40—and then widens to a dimension substantially equal to or slightly greater than the dimension of the bolt, or interference nut. To attach the removable panel 30 to the fixed panel 28 in such a configuration, the bolt 36—and preferably the interference nut 40—is slidably engaged within the panel opening 34 and manual pressure is used to pass the bolt through the smaller dimension wherein the bolt will be retained. To remove the removable panel 30, manual pressure is again used to pass the bolt 36 through the smaller dimension and out the panel opening 34.

Removability of the side panel facilitates extensive access to components residing behind the side panel. In addition, implementation of a removable panel—as compared to a partially removable or hinged panel—is more beneficial for door systems requiring periodic cleanings, e.g., NEMA washes, because complete access is enabled to the components behind the removable panel, as well as all surfaces of the removable panel, as opposed to some surfaces of the hinged panel configuration being difficult to reach.

While specific embodiments of the present invention have been illustrated and described, numerous modifications come to mind without significantly departing from the spirit of the invention, and the scope of protection is only limited by the scope of the accompanying claims.

We claim:

1. An apparatus providing access to a primary control module of a high-speed roll-up door, the primary control module including a set of control functions and being inaccessible to a user during utilization of the door, the apparatus comprising:
a secondary control module being operably connected to the primary control module, the secondary control module being readily accessible to manual operation by a user.

2. The apparatus of claim 1 wherein the secondary control module being proximate the door.

3. The apparatus of claim 2 wherein the secondary control module at least partially residing within a side door panel.

4. The apparatus of claim 1 wherein the secondary control module including a reduced set of control functions compared to the set of control functions of the primary control module.

5. A system for facilitating assembly of a high-speed roll-up door, the high-speed roll-up door including a frame positioned about an opening, the system comprising:
a fixed panel;
a removable panel;
a connector assembly attached to one of the fixed or removable panels and facilitating attaching and detaching the removable panel with the fixed panel.

6. The system of claim 5 wherein the connector assembly comprising:
a panel opening being defined by the fixed panel; and,
a bolt attached to the removable panel wherein the bolt cooperates with the panel opening and facilitates attaching and detaching the removable panel with the fixed panel.

7. The system of claim 6 further comprising:
a sleeve operably connected with the panel opening wherein the bolt cooperates with the sleeve and facilitates attaching and detaching the removable panel with the fixed panel.

8. The system of claim 6 further comprising:
a retention nut operably connected to the bolt wherein the retention nut cooperates with the panel opening and facilitates attaching and detaching the removable panel with the fixed panel.

9. For the system of claim 5, a method comprising the step of:
operably attaching the removable panel to the fixed panel.
